(19) United States
(12) Patent Application Publication
(10) Pub. No.: US 2016/0001786 A1
(43) Pub. Date: Jan. 7, 2016

(54) USER-CENTERED LOCOMOTIVE CREW CONSOLE

(71) Applicant: Foster-Miller, Inc., Waltham, MA (US)

(72) Inventors: Amanda M. DiFiore, Haverhill, MA (US); Norman L. Dana, Albion, RI (US); Robert A. Shannon, Leominster, MA (US); Philip O. Bogue, Ashby, MA (US); Richard J. Doucette, North Reading, MA (US); Abdullatif K. Zaouk, Bolton, MA (US)

(21) Appl. No.: 14/790,425

(22) Filed: Jul. 2, 2015

Related U.S. Application Data
(60) Provisional application No. 62/020,602, filed on Jul. 3, 2014.

(51) Int. Cl. B61C 17/12; B61D 33/00; B60N 2/46; B60N 3/06; B60N 2/14

(52) U.S. Cl. CPC B61C 17/12; B60N 3/063; B60N 2/14; B60N 2/4693; B61D 33/0007

(57) ABSTRACT

A locomotive crew console includes a chair with a backrest, and a seat and a footrest both foldable with respect to a frame for seated and standing operations, The chair armrest assemblies include locomotive controls. An articulating mount is coupled to an armrest assembly for one or more displays of locomotive information. A rotatable base for the frame allows the chair, the locomotive controls, and the displays to rotate with the chair.

### RELATED APPLICATIONS

This application claims benefit of and priority to U.S. Provisional Application Ser. No. 62/020,602 filed Jul. 3, 2014, under 35 U.S.C. §§119, 120, 363, 365, and 37 C.F.R. §1.55 and §1.78 which is incorporated herein by this reference.

### GOVERNMENT RIGHTS

This invention was made with U.S. Government support under Contract No. DTFR53-12-D-00009 awarded by Federal Railroad Administration. The Government may have certain rights in the subject invention

### BACKGROUND OF THE INVENTION

Existing locomotive cab designs fall into two broad design categories. The AAR 105-style control stand which includes an operator chair (accommodating sitting operations only) and floor-mounted operator console that wraps around the locomotive operator. The desk-top style control stand includes an operator chair (which also accommodates sitting operations only) and a wall-mounted desktop control console workstations. Workstations such as disclosed in U.S. Pat. Nos. 7,887,130 and 7,448,680, incorporated herein by this reference, do not meet the requirements of a properly designed locomotive crew console.

### BRIEF SUMMARY OF THE INVENTION

The physical ergonomics of prior locomotive control consoles may not conform to the functional needs of the operator. Rather, they are based on legacy design features of mechanical controls. As locomotive controls have evolved over time including electro-mechanical or servo-hydraulic controls, there has been little, if any, consideration of the design requirements from a human factors or user-centered perspective.

The invention features an ergonomically designed console for locomotive crew who control the movement of trains within the locomotive cab. One design integrates operational controls and information displays of a locomotive cab into a raised seat. The preferred seat adjusts to accommodate both sitting and standing operations and rotates 180° to accommodate forward and reverse operations.

Featured is a locomotive crew console comprising a chair including a backrest, and a seat and a footrest both foldable with respect to a frame for seated and standing operations. Chair armrest assemblies include locomotive controls and an articulating mount is coupled to an armrest assembly for one or more displays of locomotive information. A rotatable frame base enables the chair, the locomotive controls, and the displays to rotate with the chair.

The frame may further include shock absorbing means. The locomotive controls may include a right side auto-brake control, an independent brake control, and engine run group switches and a left side throttle control and reverser control. The throttle control may be a combined dynamic brake and throttle control. Preferably, the locomotive controls are modular and can be swapped between armrest assemblies. The display mount may include a mast with articulating display arms. Preferably, the display mount further includes an articulating limb connected to an armrest assembly and to the mast. The mast may be rotatable with respect to the articulating limb. In one version the articulating display arms include a pivoting display bracket and the one or more articulating arms include a shoulder joint connected to the mast, a wrist joint including a display bracket for a display, and an elbow joint between the shoulder joint and the wrist joint.

In one embodiment a locomotive crew console features a chair, armrest assemblies for the chair, locomotive controls associated with the armrest assemblies, a display mount coupled to an armrest assembly, and one or more displays on the display mount. The preferred chair includes a backrest, a seat foldable downward with respect to the backrest for standing crew operations and a footrest foldable with respect to the seat. The chair may be mounted to a rotatable frame.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three dimensional front view showing an example of a locomotive crew console in accordance with the invention;

FIG. 2 is a schematic three dimensional view of the rear of the console shown in FIG. 1;

FIG. 3 is a schematic three dimensional view of the left side of the console shown in FIGS. 1-2;

FIG. 4 is a schematic top view showing an example of a locomotive control sub-assembly associated with the left arm rest assembly shown in FIG. 3;

FIG. 5 is a schematic three dimensional view of the right side of the console shown in FIGS. 1-2;

FIG. 6 is a schematic top view showing the locomotive control sub-assembly associated with the right side arm assembly of the console shown in FIG. 5;

FIG. 7 is a schematic top view of the console shown in FIG. 1;

FIG. 8A is a schematic three dimensional view of an example of a chair assembly for the console with the seat folded down and the leg rest folded up; and

FIG. 8B is a schematic three dimensional front view showing the seat now horizontal and the leg rest folded down

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

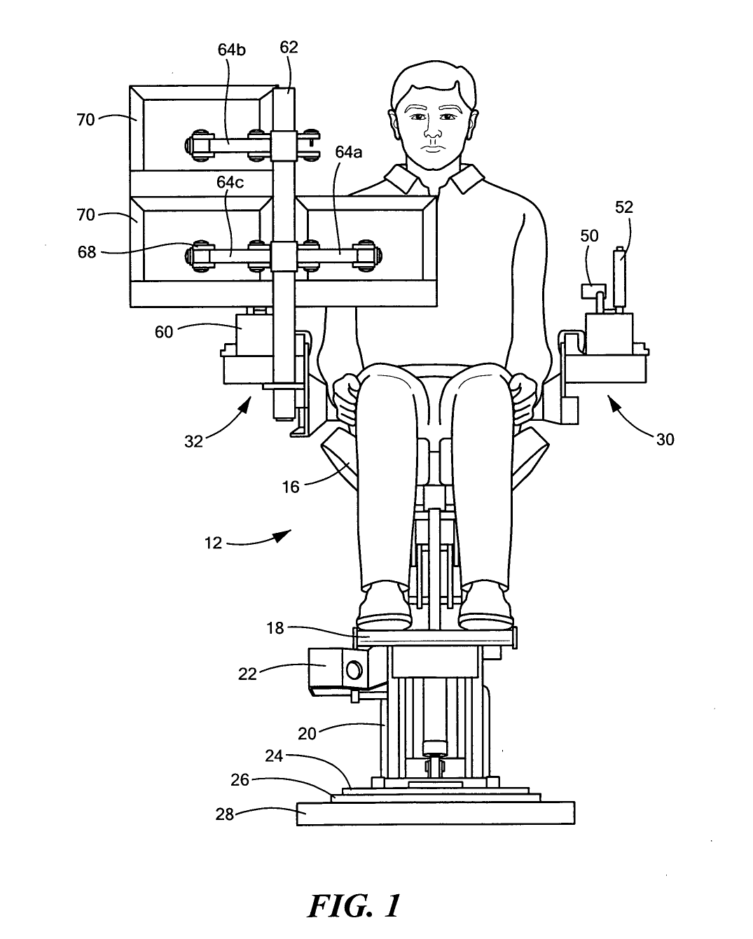

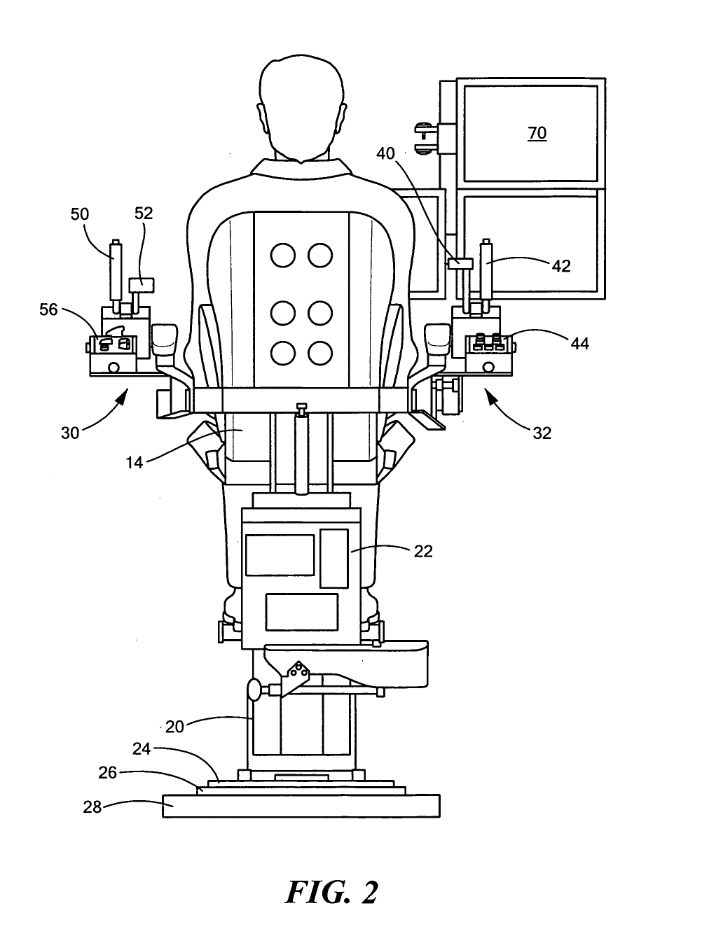

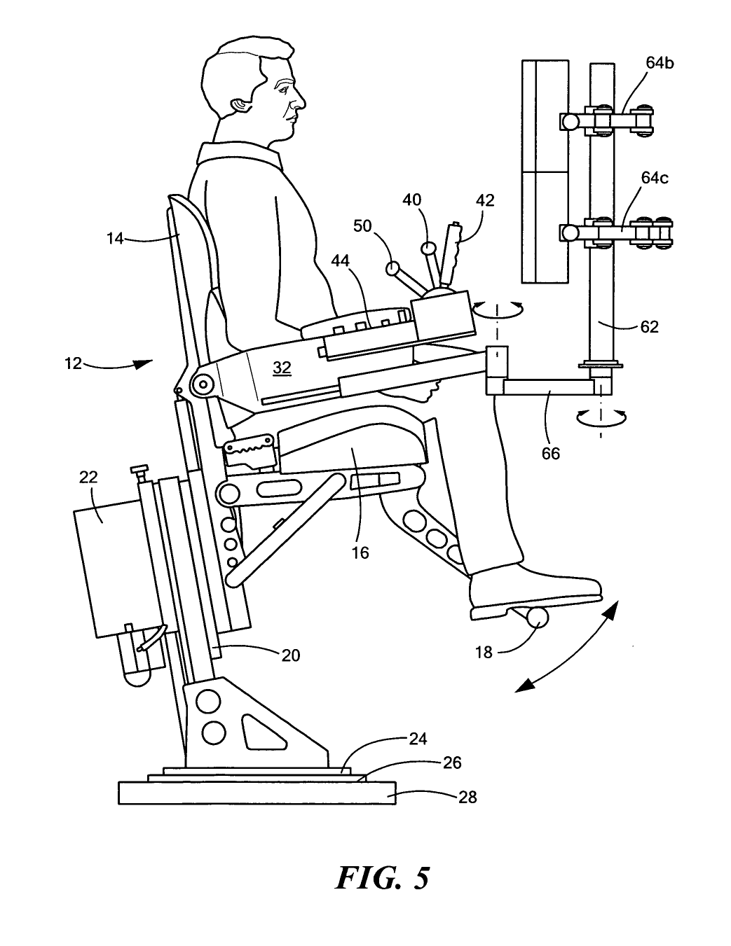

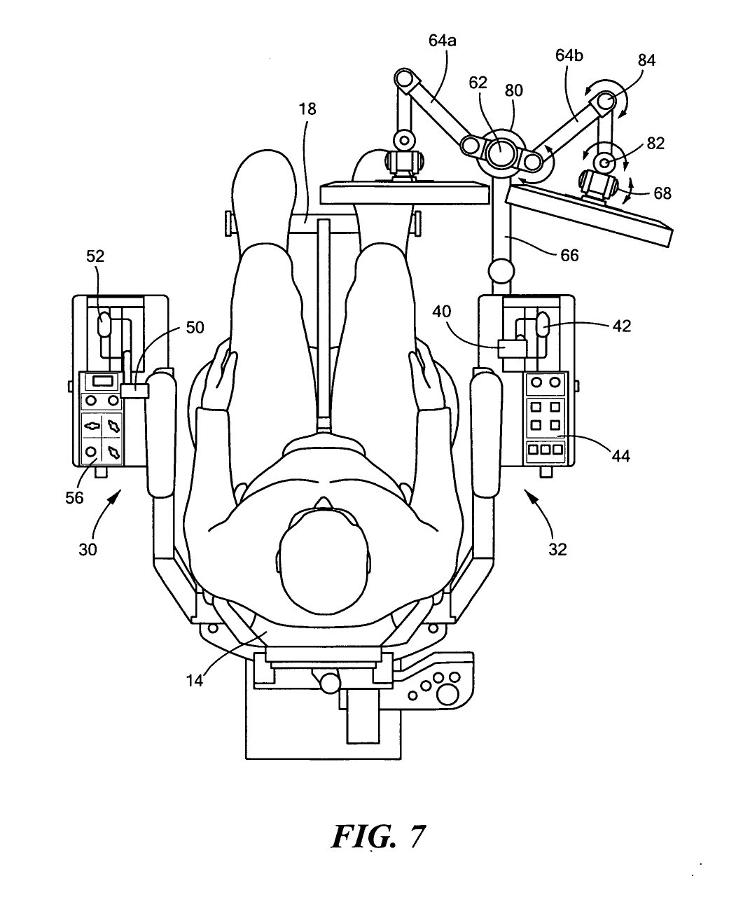

FIGS. 1-7 show a locomotive crew console comprising a chair, armrest assemblies for the chair, and locomotive controls associated with the armrest assemblies. A display mount is coupled to an armrest assembly and one or more displays are coupled to the display mount. The chair may be a customized “shock wave” brand chair assembly (Professional Component, Ltd.). The display mount may incorporate components of the Premier Mount, (Anaheim, Calif.) MM-A28 system.

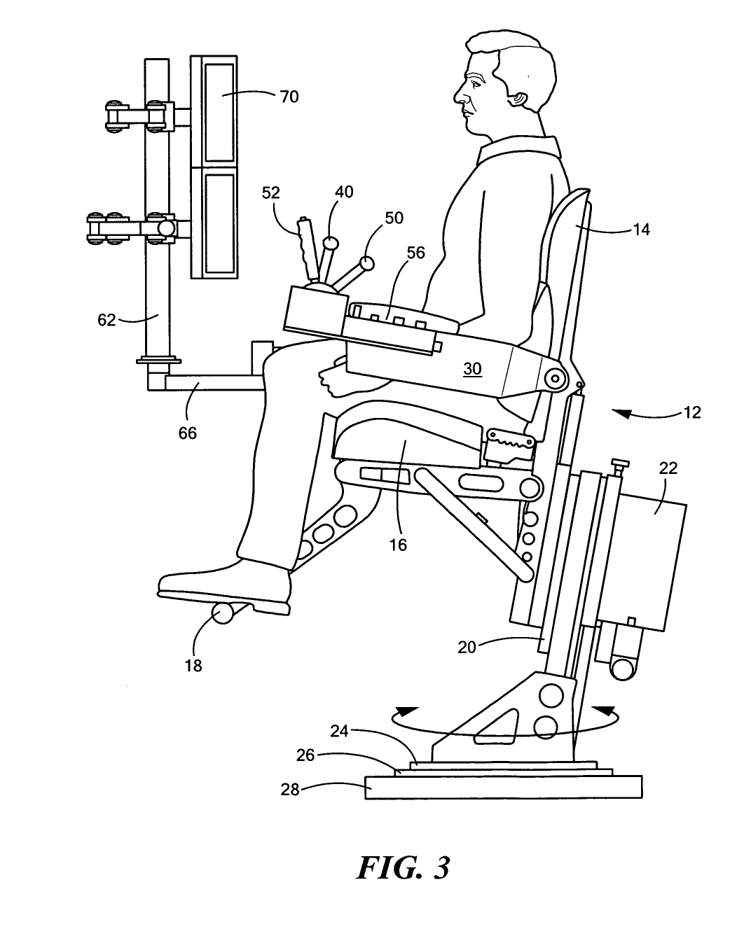

The chair 12 may include a backrest 14 and a seat 16 foldable downward with respect to the backrest for standing crew operations. The chair may also include a footrest 18 foldable (e.g., a bar or other platform) with respect to the seat. Typically, the chair is mounted to a rotatable frame 20 which includes shock absorbing means 22. Base plate 24 coupled to chair frame 20 may rotate with respect to base plate 26 coupled to pedestal 28, FIG. 3. The chair rotation mechanism may include the ability to lock the chair in place once rotated. Left arm 30 and right 32 arm rest assemblies are provided on the chair.

In one preferred design, the arm rest mounted locomotive controls include right side auto-brake control 40, an independent brake control 42, and engine run group switches 44. The left side controls include a throttle control 50 and reverser control 52. The throttle control may be a combined dynamic brake and throttle control. Left side locomotive switches 52 may control the wipers, lights, horn, bell, and the like. These controls, however, may be reversed. Preferably, the locomotive controls are modular with respect to the arm rest assemblies and can be swapped between armrest assemblies for left and right handed personnel. Certain controls can be located on the outboard side of the arm rest pad, other controls can be located forward of the arm rest pad as shown.

The resulting display mount 60 may include a mast 62 with articulating display arms 64a, 64b, 64e, etc. The display mount may further include an articulating limb 66 connected to an armrest assembly and to the mast as shown. Preferably, the mast is rotatable with respect to the articulating limb. Also, each articulating display arm may include a pivoting display bracket 68 to adjust the pitch angle of a display 70. The one or more articulating arms may include a shoulder joint 80 connected to the mast, a wrist joint 82 including a display bracket for a display, and an elbow joint 84 between the shoulder joint and the wrist joint.

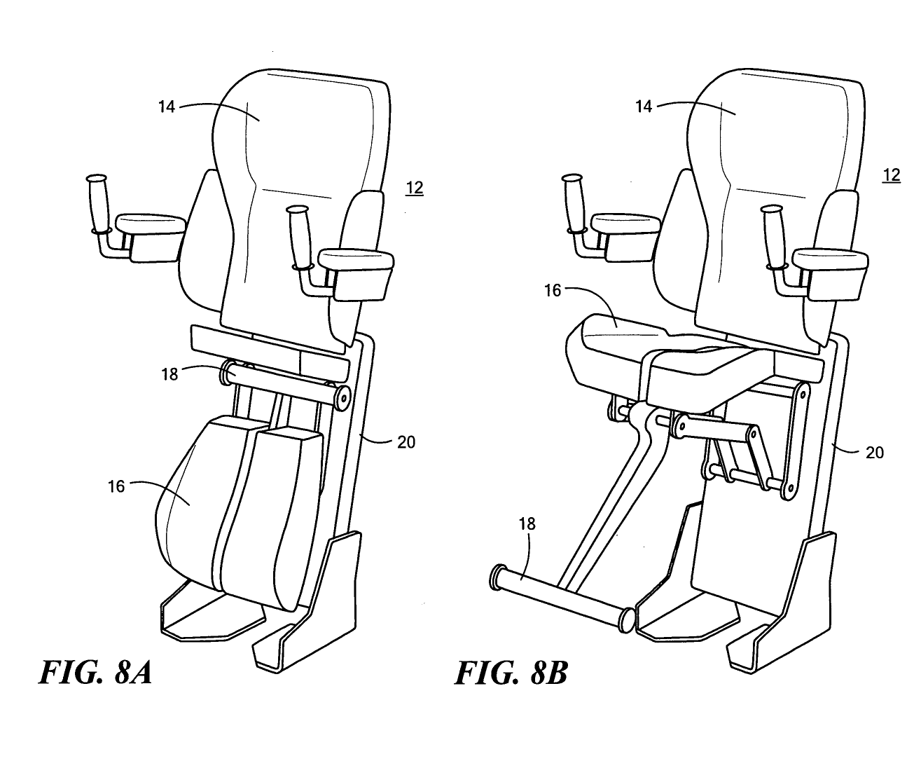

One user-centered locomotive crew console is a new design for the work space of locomotive cab operators. One novel design considers the functional requirements of the operator's work space. The information displays and controls are arranged with regard to how a locomotive engineer interacts with them. With regard to displays 70, the monitors in front of the operator are preferably adjustable both in height and in orientation to accommodate a range of different sized locomotive engineers, the 5^{th}-95^{th} percentile male and female. The controls are located in close proximity to the arms of the chair and are arranged according to frequency of use. The most frequently accessed controls are usually made more easily accessible than secondary controls which are accessed less often. The entire console may rotate 180° to accommodate forward and reverse operations of the locomotive without requiring the operator to bend or twist. The preferred console is designed to accommodate sitting and standing operations as well. See FIG. 8. Standing operations are not a job requirement but this feature relieves the operator of sitting for prolonged periods of time. This provides relief from spinal stress during long work shifts of 8-12 h.

A seating solution is provided that is fully integrated with locomotive controls and displays to allow for 180° rotation. Existing cab work spaces require the operator to twist the back and neck to view movement of the train in reverse operations. The controls and displays are not easily accessible when the operator is in this “twisted” position. This new console allows the operator to rotate the entire work space without compromising optimal work posture all the while giving the operator access to displays and controls. The layout of the controls and displays enable the same functionality as existing cab controls and displays but reduce the clutter of controls of existing designs. The controls are grouped by function and primary controls are easily accessible.

The controls and displays are integrated into the seat of the crew console so that when the seat rotates, the controls and displays also rotate as a single operational unit. Locomotive controls are preferably embedded into the arm rest assemblies of the seat. The arm rests of the seat may be adjustable in the fore and aft direction. Rotation of the entire unit assures that the operator has access to all controls and information regardless of standing, sitting, reverse or forward operations in contrast to existing crew consoles. The displays may display locomotive information such as speed, the status or setting of the various locomotive controls, warning messages or images, diesel engine sensor data, images from cameras, and the like.

The dynamic brake and throttle may be combined into a single control mechanism. The preferred design includes LED indicators of position and includes a flashing LED indicator when the control is in the set-up position. In actual operations, the locomotive operator is instructed to wait 10 sec after placing the control in the set-up position before engaging the dynamic brake. However, in prior systems there is no indicator that the 10 sec have elapsed and the control is ready for dynamic brake engagement. Here, a white LED indicator light blinks for 10 sec when setup is selected on the control. After 10 sec, the white LED light becomes solid indicating system readiness for using the dynamic brake. The control module thus includes logic which triggers a white blinking LED light after the throttle has been engaged in any notched position including idle. The logic of the electrical control signals the light to blink for 10 sec. After 10 sec, the light remains illuminated and constant until the control is placed into a dynamic braking position—at which time the white light is no longer illuminated.

The control modules in the chair arms may be fully modular and can be swapped to accommodate right- or left-handed individuals. The control modules may be manufactured with USB-type or other industrial-type connectors that feed into a centralized electrical control box located on the posterior portion of the crew console.

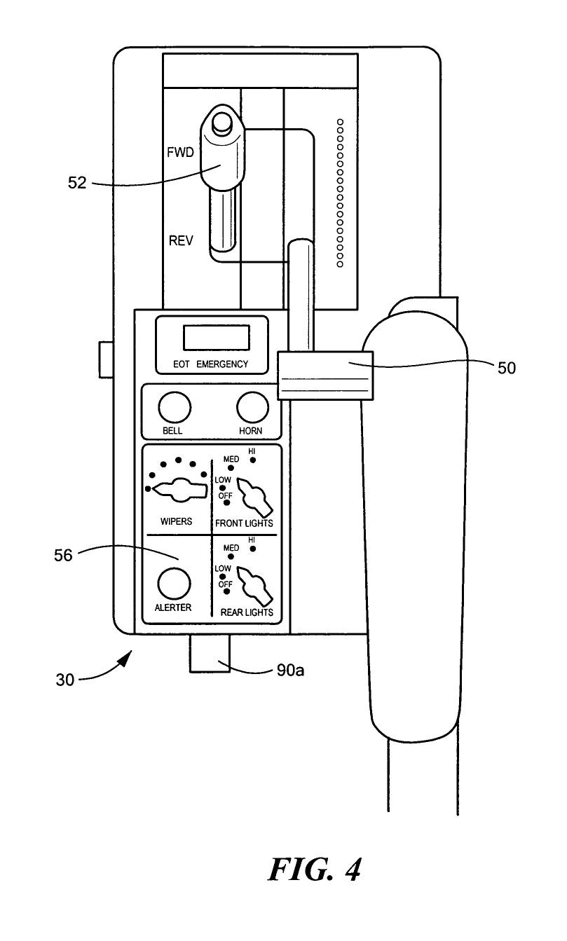

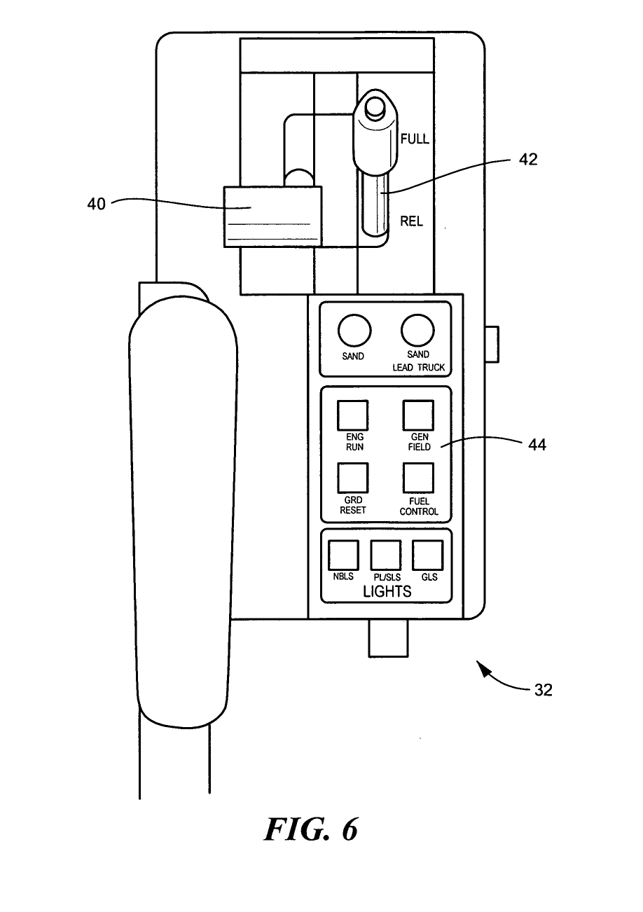

Electrical wiring controlling each control modules extends through both arms of the console's chair. The wiring terminates into four sets of connectors on each arm assembly that correspond to the four control boxes of the crew console. This wiring configuration enables connecting any of the four control box assemblies to either arm. See USB connectors 90a, FIG. 4 and 90b, FIG. 6.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A locomotive crew console comprising:
a chair including a backrest, and a seat and a footrest both foldable with respect to a frame for seated and standing operations;
chair armrest assemblies including locomotive controls;
an articulating mount coupled to an armrest assembly for one or more displays of locomotive information;
and a rotatable base for the frame so that the chair, the locomotive controls, and the displays rotate with the chair.

2. The console of claim 1 in which the frame further includes shock absorbing means.

3. The console of claim 1 in which the locomotive controls include a right side auto-brake control, an independent brake control, and engine run group switches and a left side throttle control and reverser control.

4. The console of claim 3 in which the throttle control is a combined dynamic brake and throttle control.

5. The console of claim 1 in which the locomotive controls are modular and can be swapped between armrest assemblies.

6. The console of claim 1 in which the display mount includes a mast with articulating display arms.

7. The console of claim 6 in which the display mount further includes an articulating limb connected to an armrest assembly and to the mast.

8. The console of claim 7 in which the mast is rotatable with respect to the articulating limb.

9. The console of claim 6 in which the articulating display arms include a pivoting display bracket.

10. The console of claim 6 in which the one or more articulating arms include a shoulder joint connected to the mast, a wrist joint including a display bracket for a display, and an elbow joint between the shoulder joint and the wrist joint.

11. A locomotive crew console comprising:
a chair;
armrest assemblies for the chair;
locomotive controls associated with the armrest assemblies;
a display mount coupled to an armrest assembly; and
one or more displays on the display mount.

12. The console of claim 11 in which the chair includes a backrest and a seat foldable downward with respect to the backrest for standing crew operations.

13. The console of claim 12 in which the chair includes a footrest foldable with respect to the seat.

14. The console of claim 11 in which the chair is mounted to a rotatable frame.

15. The console of claim 14 in which the frame includes shock absorbing means.

16. The console of claim 11 in which the locomotive controls include a right side auto-brake control, an independent brake control, and engine run group switches and a left side throttle control and reverser control.

17. The console of claim 16 in which the throttle control is a combined dynamic brake and throttle control.

18. The console of claim 11 in which the locomotive controls are modular and can be swapped between armrest assemblies.

19. The console of claim 11 in which the display mount includes a mast with articulating display arms.

20. The console of claim 19 in which the display mount further includes an articulating limb connected to an armrest assembly and to the mast.

21. The console of claim 20 in which the mast is rotatable with respect to the articulating limb.

22. The console of claim 16 in which the articulating display arms includes a pivoting display bracket.

23. The console of claim 19 in which the one or more articulating arms include a shoulder joint connected to the mast, a wrist joint including a display bracket for a display, and an elbow joint between the shoulder joint and the wrist joint.
